(19) United States
(12) Patent Application Publication
(10) Pub. No.: US 2016/0340079 A1
(43) Pub. Date: Nov. 24, 2016

(54) CONTAINER FOR CARBONATED LIQUID AND PACK COMPRISING A PLURALITY OF CONTAINERS

(71) Applicant: SIDEL PARTICIPATIONS, Octeville-sur-Mer (FR)

(72) Inventor: Vincent LE GUEN, Octeville-sur-Mer (FR)

(73) Assignee: SIDEL PARTICIPATIONS, Octeville-sur-Mer (FR)

(21) Appl. No.: 15/110,796

(22) PCT Filed: Jan. 28, 2015
(86) PCT No.: PCT/FR2015/050197

§ 371 Date: Jul. 11, 2016

(30) Foreign Application Priority Data
Feb. 14, 2014 (FR) 14 51183

(51) Int. Cl. B65D 21/02; B65B 3/02; B29C 49/48; B65D 1/02; B29C 49/10; B65D 71/08; B65D 71/42

(52) U.S. Cl. CPC B65D 21/0202; B65D 71/08; B65B 3/022; B65D 71/42; B65D 1/0276; B29C 49/10; B29C 49/48; B29C 2049/4879; B29L 2031/7158

(57) ABSTRACT

A hollow container, for liquid, made of plastics material, includes a dome-shaped bottom integral with a body, the bottom and body have a single axis of rotational symmetry (Z), the body including a first, upper part and a second, lower part, the second, lower part being integral with the bottom, the first and second parts being connected together by an intermediate zone, the first and second parts each having a substantially concave shape, the concavity being turned towards the axis of symmetry (Z) of the body. The concave shape of the first part is approximately the same as the concave shape of the second part. The intermediate zone has a convex shape, the convexity being turned towards the axis of symmetry (Z) of the body. In a plane including the axis of symmetry of the body, the concavity and the convexity are substantially complementary.

The invention relates to a container for liquid, in particular for gaseous liquid, as well as a pack of multiple containers in accordance with the invention, arranged in such a way as to occupy the least possible space.

In a general manner, the invention relates to the field of the manufacturing of containers, in particular bottles, made of thermoplastic material such as PET, by blow molding or stretch blow molding of preforms in molds, with the containers being designed not to deform under the action of an internal pressure, for example bottles designed to contain a fizzy drink, such as a naturally gaseous liquid, for example gaseous water, or a gasified or carbonated liquid, for example a soda.

When such containers are produced, it is necessary to give them a particular shape that makes it possible for them to withstand the internal pressure. In particular, the bottom of the container is often made dome-shaped or more or less hemispherical to ensure sufficient resistance to pressure, with the bottom constituting a weak point in the design of such containers.

A hemispherical or dome-shaped bottom does not make it possible to allow the container to rest on a flat base. Also, such containers are often associated with rings or with cups, connected to the hemispherical bottom of the containers, which make it possible to place the containers upright on a flat base.

The document FR 2 357 437 describes an example of such containers.

In particular, the objective of the invention is to eliminate the need for such rings or cups for the packaging of containers in packs and for their transport.

Consequently, the stability problem of the containers is posed again.

The object of the invention is to remedy this problem.

The object of the invention is also to reduce the space requirement of the packs of containers.

For this purpose, the invention proposes a container for gaseous liquid, made of plastic material, comprising a dome-shaped bottom that is integral with a body, the bottom and the body having the same rotational axis of symmetry, with said body comprising a first upper part and a second lower part, with the second lower part being integral with the bottom, said first and second parts being connected to one another by an intermediate zone, with the first and second parts each having an essentially concave shape whose concavity faces toward the axis of symmetry of the body.

In relation to the state of the art, the container in accordance with the invention is noteworthy in that the concave shape of the first part is essentially the same as the concave shape of the second part, in that the intermediate zone has a convex shape, whose convexity faces toward the axis of symmetry of the body, and in that in a plane that comprises said axis of symmetry, said convexity and said concavity are essentially complementary.

Owing to these special features, a portion of a container in accordance with the invention (first upper part or second lower part) can interlock in the intermediate zone of a second container in accordance with the invention. In this way, multiple contiguous containers in accordance with the invention are interlocked with one another, with the bottoms of the containers being offset in relation to one another, which makes possible a savings in space in the volume occupied by multiple containers (compared to the volume occupied by as many containers but that would not comprise the characteristics that belong to the invention).

The stability of a pack of multiple containers is obtained with at least four containers, of which three form the vertices of a lift triangle, surrounding the fourth container offset vertically (see the later embodiments).

According to the invention, the container can comprise the following characteristics:
The concavity and the convexity can have an essentially partially spherical shape of the same diameter. This characteristic is ideal for the distribution of the forces internal to the container against the wall of the container, due to the presence of gas once the containers are filled. The containers thus have less tendency to deform once filled;
The intermediate zone can be surrounded by a holding strip to preserve the shapes of the upper and lower parts by compressing the intermediate zone;
The container can be filled with a gaseous liquid.

The invention also relates to a process for manufacturing a container as defined above, filled with a gaseous liquid and having a holding strip surrounding the intermediate zone. The process in accordance with the invention comprises the following steps:
Producing the hollow container by blow molding or stretch blow molding of a preform in a mold that has an impression that can produce a container comprising a dome-shaped bottom that is integral with a body, with the bottom and the body having the same rotational axis of symmetry, said body comprising a first upper part and a second lower part, with the second lower part being integral with the bottom, said first and second parts being connected to one another by an intermediate zone, the first and second parts each having an essentially concave shape whose concavity faces toward the axis of symmetry of the body, the concave shape of the first part being essentially the same as the concave shape of the second part, the intermediate zone having a convex shape, whose convexity faces toward the axis of symmetry of the body and, in a plane that comprises said axis of symmetry of the body, said convexity and said concavity being essentially complementary for making possible the interlocking of a first or second part of a container in an intermediate zone of a second container,
Filling the hollow container with a gaseous liquid,
And attaching a holding strip around the body of the container in the intermediate zone, after the filling step.

This process is particularly designed for the production of containers in accordance with the invention containing a naturally gaseous liquid, for example a mineral water.

The object of the invention is also a process for manufacturing a container as defined above, filled with a gasified liquid, such as a liquid that is carbonated by the addition of carbonic gas, and having a holding strip surrounding the intermediate zone. The process in accordance with the invention comprises the following steps:
Producing the hollow container by blow molding or stretch blow molding of a preform in a mold that has an impression that can produce a container comprising a dome-shaped bottom that is integral with a body, the bottom and the body having the same rotational axis of symmetry, said body comprising a first upper part and a second lower part, the second lower part being integral with the bottom, said first and second parts being connected to one another by an intermediate zone, with the first and second parts each having an essentially concave shape whose concavity faces toward the axis of symmetry of the body, the concave shape of the first part being essentially the same as the concave shape of the second part, the intermediate zone having a convex shape, whose convexity faces toward the axis of symmetry of the body and, in a plane that comprises said axis of symmetry of the body, said convexity and said concavity being essentially complementary for making possible the interlocking of a first or second part of a container in an intermediate zone of a second container,
Filling the hollow container with a liquid,
Adding gas into the liquid in such a way as to obtain a gasified liquid,
And attaching a holding strip around the body of the container in the intermediate zone, after the step of adding gas.

The invention also has as its object the production of a pack comprising at least four containers as defined above. In accordance with the invention, two contiguous containers are positioned in such a manner that the first part or the second part of one is inserted into the intermediate zone of the other. In this case, the pack can be arranged in such a way that three containers each have at least one point of their bottom in the same plane in such a way that the bottom of each of the at least three containers is able to be in contact with the same flat base. The three containers thus ensure the stability of the entire pack on the flat base.

The pack of containers in accordance with the invention can also comprise the following characteristics taken separately or taken in combination:
The containers are oriented in the same direction and in the same sense;
The containers are oriented in the same direction and positioned head to foot;
The containers are held in position by a heat-shrink film;
The containers are held in position by a cardboard strip surrounding the pack.

To be able to be executed, the invention is disclosed in a sufficiently clear and complete way in the following description that is in addition accompanied by drawings in which:

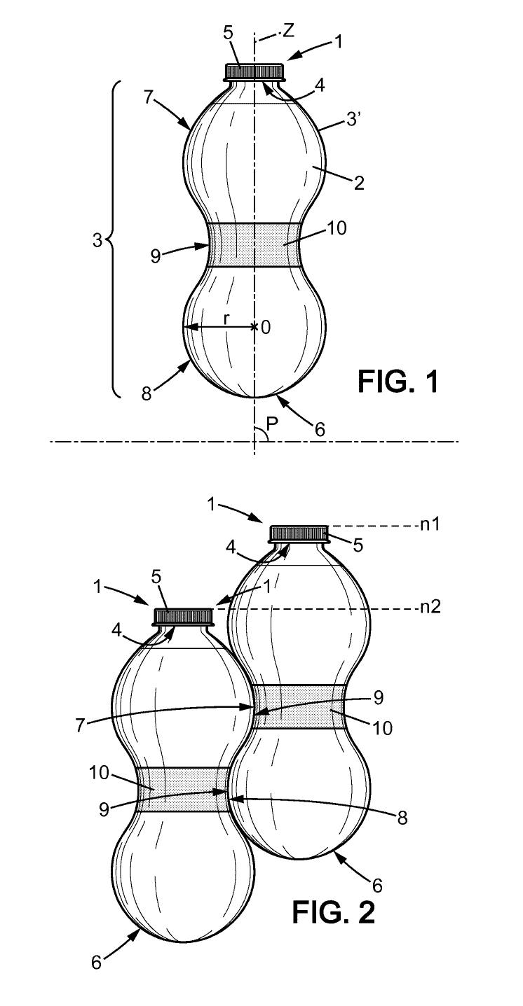

FIG. 1 is a side view of a container in accordance with the invention,

FIG. 2 is a side view of two containers in accordance with the invention, interlocked in one another,

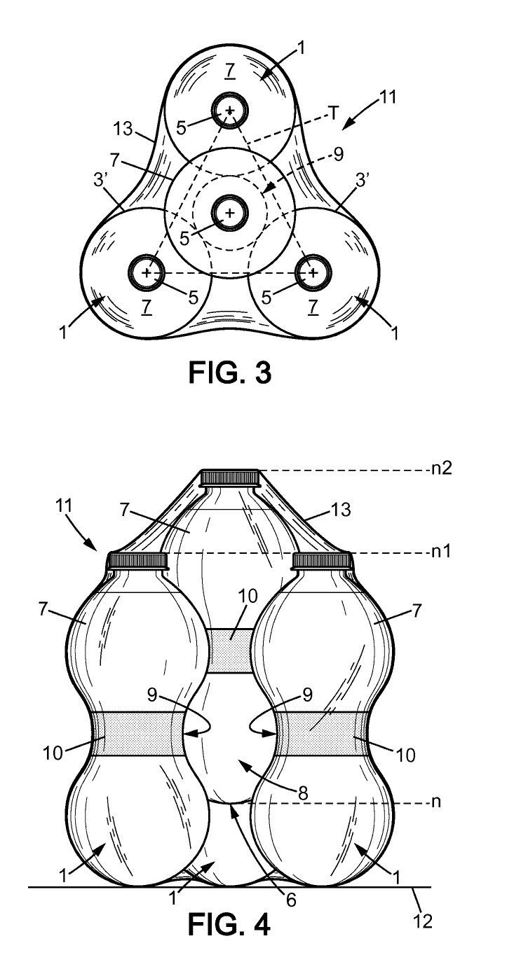

FIG. 3 is a top view of a first pack of containers in accordance with the invention,

FIG. 4 is a side view of the pack illustrated in FIG. 3,

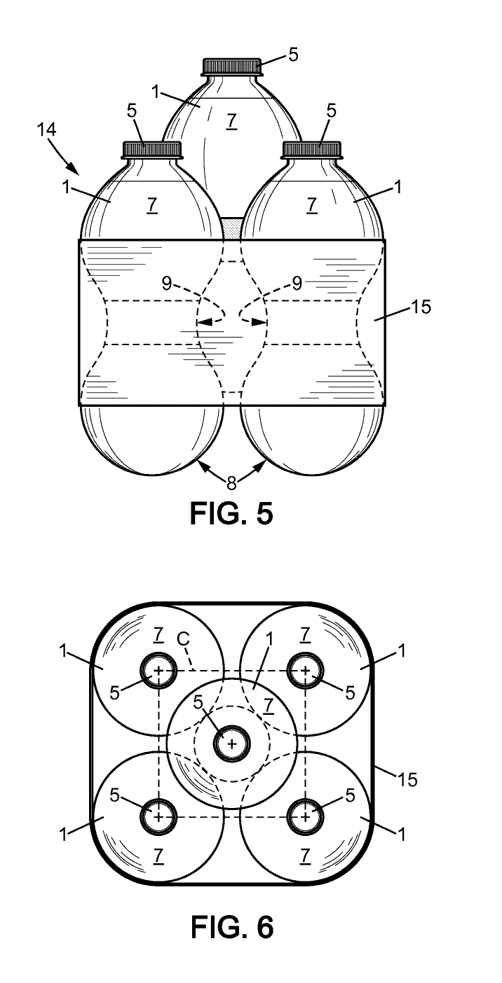

FIG. 5 is a side view of a second pack of containers in accordance with the invention,

FIG. 6 is a top view of the pack illustrated in FIG. 5,

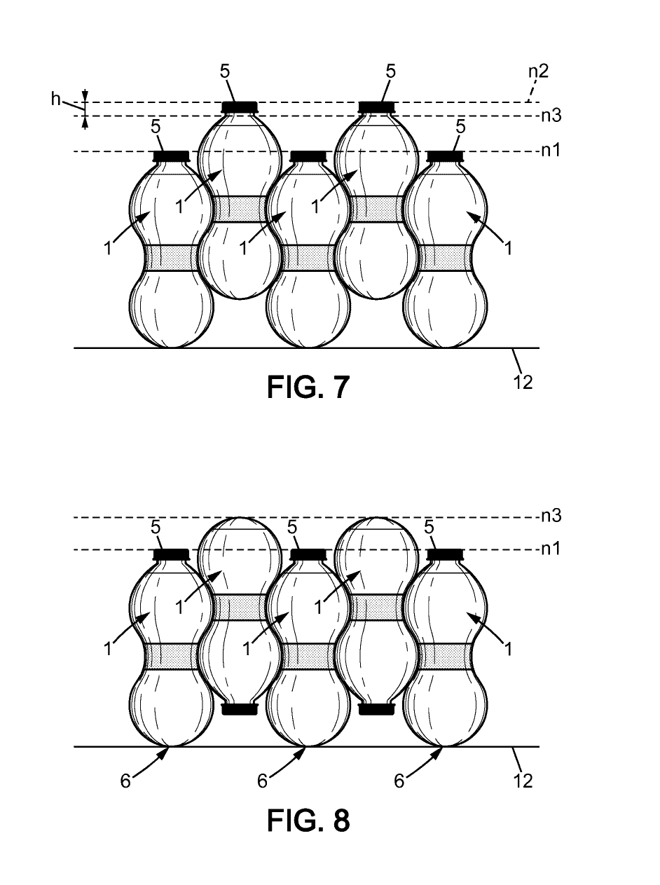

FIG. 7 is a side view of another pack of containers in accordance with the invention, placed according to a first interlocking mode,

And FIG. 8 is a side view of another pack of containers in accordance with the invention, placed according to a second interlocking mode.

In the following description, the terms “lower,” “upper”, “top,” “bottom,” etc., are used with reference to the drawings for a greater ease of understanding. They should not be understood as being the limitations of the scope of the invention.

FIG. 1 shows a hollow container 1 in accordance with the invention, made of plastic material, such as PET, by blow molding or stretch blow molding of a preform in a mold.

The hollow container 1 is filled with a gaseous liquid 2, such as a gaseous-water-type drink, or a carbonated liquid, such as a soda.

According to the example illustrated in the figures, the hollow container 1 comprises a body 3 extending along a main axis Z, and has a side wall 3′ with rotational symmetry around the main axis Z. In the upper part of the container 1, the side wall 3′ is compressed to create a spout of the container, called a neck 4, comprising an upper opening that is hermetically sealed by a cap 5, such as a stopper, a lid, or a top. In the lower part, in the continuation of the side wall 3′, the container 1 comprises a bottom 6 whose wall follows a circular generatrix whose center O is positioned on the main axis Z and whose radius r corresponds to the widest distance between the main axis Z and the side wall 3′. Thus, the bottom 6 of the container 1 forms a spherical cap, for example a semi-sphere, which constitutes a rounded shape or dome shape toward the outside of the container 1, particularly suited for withstanding stresses due to the filling of the container 1 by a gaseous or gasified liquid.

The body 3 of the container comprises multiple parts and, in particular, a first upper part 7 located below the neck 4.

The body 3 of the container 1 also comprises a second inside part 8 that is integral with the bottom 6 of the container 1, formed partially in the continuity of the spherical cap of the bottom 6. The second part 8 thus has, when seen in a plane that is parallel to the main axis Z, a concave shape whose concavity faces toward the axis of symmetry Z of the body 3 of the container 1.

The first part 7 has, when seen in a plane that is parallel to the main axis Z, essentially the same concave shape as the second part 8, whose concavity also faces toward the main axis Z of the body 3 of the container 1.

The first and second parts 7 and 8 are connected to one another by an intermediate zone 9.

The intermediate zone 9 is surrounded by a strip 10 that ensures pressure on the wall 3′ in such a way that the intermediate zone 9 does not deform under the action of the internal pressure in the container 1, with the pressure being due to the presence of gas in the liquid 2 that is contained in the container.

Unlike the first and second parts 7 and 8, the intermediate zone 9 has a convex shape, whose convexity faces toward the axis of symmetry Z. If a plane of symmetry P that comprises the axis of symmetry Z (i.e., a vertical cutting plane for the container 1 shown in FIG. 1) is considered, the convexity of the intermediate zone 9 creates a hollow whose concavity is oriented opposite that of the first and second parts 7 and 8, and is complementary to one and the other of the first and second parts 7 and 8. In other words, the hollow of the intermediate zone 9, on the one hand, and the hollows of the first and second parts 7 and 8, on the other hand, respectively face toward the outside and toward the inside of the container 1. In still other words, the first part 7 and the second part 8 are bent toward the outside of the container 1, while the intermediate zone 9 is bent toward the inside of the container 1.

Thus, two containers 1 can be interlocked in one another: the first part 7 of a first container is inserted into the intermediate zone 9 of the second container 1, while the second part 8 of the second container 1 is inserted into the intermediate zone 9 of the first container 1.

According to an embodiment, the first and second parts 7 and 8 are truncated spheres.

For example, and as illustrated in the example of the figures, by following the curvature of the spherical cap of the bottom 6, the second part 8 is itself a partially spherical shape. The first part 7 is then also a partially spherical shape and of the same diameter as the shape of the second part 8 of the body 3. The hollow shape of the intermediate zone 9 is essentially the same as that of the two hollows formed by the two concavities of the first and second parts 7 and 8, but oriented in the opposite direction. The convexity of the intermediate zone 9 is thus complementary to the concavity of the first and second parts 7 and 8.

According to the example illustrated in the figures, because of the rotational symmetry around the main axis Z, any cross-section of the body 3 of the container 1 in a plane perpendicular to the axis of revolution Z is a circle, the circle of smaller diameter, except for the bottom 6, being in the intermediate zone 9. The overall shape of the container 1 is thus comparable to the shape of a peanut.

The spherical shape of the first and second parts 7 and 8 has a certain advantage when the container 1 is filled with a gaseous liquid, since it makes it possible to increase the resistance of the container 1 to the internal pressure.

With the shape of the hollows being essentially the same, this makes possible the insertion with contact of the first part 7 of a first container 1 in the intermediate zone 9 of a second container 1, as shown in FIG. 2, and, in a similar manner, the insertion with contact of the second part 8 of the second container 1 in the intermediate zone 9 of the first container 1. In other words, the side wall 3′ of the first container 1 in the area of its intermediate zone 9 is in contact with the side wall 3′ of the second container 1 in the area of its second part 8, and likewise, the side wall 3′ of the second container 1 in the area of its intermediate zone 9 is in contact with the side wall 3′ of the first container 1 in the area of its first part 7. The first container 1 is then closely interlocked with the second container 1, which makes it possible to have a minimal space requirement.

The two containers 1 are, for example, oriented in the same direction, i.e., with their neck 4 positioned upward. They are, however, offset vertically in relation to one another because of the interlocking of the upper part 7 and lower part 8 in the intermediate zones 9: the caps 5 of the two hollow containers 1 are at different levels n1 and n2.

The two interlocked containers 1 thus occupy less surface than two containers positioned one beside the other but not interlocked in one another.

Thanks to the particular shape of the containers 1 in accordance with the invention, it is possible to produce different interlockings of containers with one another, ensuring the formation of packs of multiple containers that occupy less space overall than the packs of containers that are currently found, whose containers 1 are placed beside one another with their bottoms 6 resting on a flat base.

FIGS. 3 and 4 show a first example of a pack 11 of containers 1 in accordance with the invention, comprising four containers in accordance with the invention and identical to one another.

The pack 11 is designed to have the containers 1 in an upright position (i.e., in a vertical position with the caps 5 oriented upward) and for resting in a stable way on a flat base 12.

To do this, it is necessary that the bottoms 6 of the three containers 1 rest on the flat base 12, each by at least one point of contact, in such a way that the points of contact of each of these three containers 1 with the flat base 12 form the three vertices of a lift triangle T (shown in FIG. 3), ensuring the equilibrium of the pack 11. The lift triangle T is an equilateral triangle.

The three containers 1 ensuring the equilibrium of the pack 11 are the containers 1 whose caps 5 are at a first level n1 in FIG. 4.

The fourth container 1 is interlocked between the three containers 1 ensuring the equilibrium of the pack 11: the second part 8 of the body 3 of the fourth pack 1 is inserted into the intermediate zones 9 of the bodies 3 of the containers ensuring the equilibrium of the pack 11. Because the triangle T is equilateral, the main axis Z of the fourth container 1 is found in the center of the triangle T, which ensures great stability to the pack 11.

Thus, the bottom 6 of the fourth container 1 is at a level n above the level of the flat base 12, and the cap 5 of the fourth container 1 is located at a level n2 above the level n1 of the three caps 5 of the three containers 1 ensuring the equilibrium of the pack 11.

To hold in position the containers 1 that form the pack 11, a heat-shrink film 13 surrounds the pack 11.

Thus produced, the pack 11 occupies less surface on the flat base 12 than a standard pack of four containers. The pack 11, however, spreads out over a larger height (corresponding to the level n2) than the standard height (corresponding to the level n1) of a standard pack of four containers.

It is possible, however, to slightly reduce the level n2 by positioning the containers 1 head to foot, as illustrated in FIG. 8.

In this configuration, the containers 1 that are interlocked in one another are placed with neck 4 at the top or neck 4 at the bottom, one-half of the time. More particularly, three containers 1 are placed with neck 4 at the top and rest with their dome-shaped bottoms 6 on the flat base 12. Two containers 1 are placed with neck 4 at the bottom, between the containers 1 placed with neck 4 at the top, by being interlocked in the containers 1 placed with neck 4 at the top.

The caps 5 of the containers 1 placed with neck 4 at the top are located at a level n1.

The bottoms 6 of the containers 1 placed with neck 4 at the bottom are located at a level n3.

FIG. 7 shows the same interlocking of the containers 1, but the containers 1 are all positioned with neck 4 at the top. The caps of the two interlocked containers 1 reach a level n2 as seen above (FIG. 2).

The level n2 is located above the level n3. The difference in height between the levels n2 and n3 essentially corresponds to the height h of the cap 5 and the neck 4 of the container 1 on which the cap 5 is attached by screwing (for example).

Thus, by positioning the containers 1 head to foot, the packs occupy less space in height than in the case where all of the containers 1 are positioned in the same direction.

It should be understood that the invention is not specifically limited to the embodiment of a pack 11 of four containers 1. Other configurations can be considered and can correspond to the invention.

For example, the two packs illustrated in FIGS. 7 and 8 are configurations corresponding to the invention.

Likewise, the embodiment of a pack 14 of five containers 1, such as the one illustrated in FIGS. 5 and 6, also corresponds to a pack of containers in accordance with the invention.

Within the framework of this embodiment, four containers 1 form four feet ensuring the stability of the pack 14, by being placed at the vertices of a square C (see FIG. 6).

A central container is interlocked between the four containers 1 ensuring the stability, in such a way that the second part of the central container 1 enters into each of the intermediate zones 9 of the four containers ensuring the stability of the pack 14.

With regard to the dimensions of the containers, it would also be possible to provide more containers 1 in a pack without exceeding the scope of the invention.

Within the framework of the embodiment illustrated in FIG. 5, the containers are held in place by being surrounded by a cardboard strip 15 that can be used as an advertising medium, for example, or as a medium for any other information relative to the product contained in the containers 1 of the pack 14.

Reference will now be made to two examples of processes for manufacturing containers 1.

Currently, two categories of gaseous liquids are packaged and marketed: there are naturally gaseous products, such as certain mineral waters, and there are carbonated products, of the soda type, which initially are flat liquid products to which gases are added, in a second step.

Two processes are therefore implemented for packaging these two sorts of products.

The processes have, however, multiple steps in common.

The first step in common consists in producing the hollow container, by blow molding or stretch blow molding of a preform made of plastic material in a mold. The mold has an internal impression that makes it possible to obtain the shape of the container in accordance with the invention, i.e., a container 1 comprising two upper and lower parts 7 and 8 with a shape that is essentially at least partially spherical, separated by an intermediate zone 9 in the shape of an hourglass, thus having a hollow shape that can receive one or the other of the at least partially spherical upper and lower parts of the same adjacent container.

The second step in common consists in filling the container with the flat or naturally gaseous liquid.

If the liquid is flat, the next step consists in incorporating gas into the liquid, then in attaching a holding strip 10 around the zone 9 so that the latter does not deform under the action of the internal pressure in the container 1.

If the liquid is naturally gaseous, then the next step consists only in attaching the holding strip 10 around the zone 9.

From the preceding description, it is understood how the invention makes it possible to solve space requirement problems linked to the packaging of containers, while ensuring optimal resistance to the internal pressure in the case of carbonated liquids.

In particular, it is understood how the shape of the wall of the body of the bottle makes possible an interlocking of containers in one another, which makes it possible to reduce the overall space requirement of a pack of containers in accordance with the invention.

It should be understood, however, that the invention is not limited to the embodiments described.

In particular, only one container with partially spherical first and second parts has been described and presented. A container that has other concave and convex shapes in the area of the lower and upper parts and of the transition zone can correspond to a container in accordance with the invention.

For example, the first and second parts 7 and 8 can be non-circular. In addition, the shape of the intermediate zone 9 is not necessarily identical to that of the first and second parts 7 and 8. Finally, the container 1 may not be symmetrical in revolution. In this case, the first and second parts 7 and 8 and the intermediate zone 9 are adapted in such a way that the intermediate zone 9 forms a housing for one and the other of the first and second parts 7 and 8 in a determined portion of the side wall 3′ of the container, imposing an orientation for being able to interlock the containers 1.

Finally, it is perfectly comprehensible that if the main advantage of the container of the invention lies in being filled with a gaseous liquid, because of its high resistance to the stresses of internal pressure, it is entirely usable for a flat liquid, and, in this case, it retains the advantage of its great facility to create stable packs that make possible a savings in storage space.

1. Hollow container (1), made of plastic material, comprising a dome-shaped bottom (6) that is integral with a body (3) extending along a main axis (Z), with said body (3) comprising a first upper part (7) and a second lower part (8), with the second lower part (8) being integral with the bottom (6), said first and second parts (7, 8) being connected to one another by an intermediate zone (9), with the first and second parts (7, 8) each having an essentially concave shape whose concavity faces toward the main axis (Z) of the body (3), wherein
the concave shape of the first part (7) is essentially the same as the concave shape of the second part (8),
the intermediate zone (9) has a convex shape, whose convexity faces toward the main axis (Z) of the body (3),
and, in a plane (P) comprising said main axis (Z) of the body (3), said concavity and said convexity are essentially complementary.

2. Container according to claim 1, wherein said concavity and said convexity are essentially of partially spherical shape, of the same diameter.

3. Container according to claim 1, wherein the intermediate zone (9) is surrounded by a holding strip (10).

4. Container according to claim 3, wherein the container is filled with a gaseous liquid (2).

5. Process for manufacturing a container according to claim 4, comprising the following steps:
producing the hollow container (1) by blow molding or stretch blow molding of a preform in a mold that has an impression that can produce a container comprising a dome-shaped bottom (6) that is integral with a body (3), with the bottom (6) and the body (3) having the same rotational axis (Z) of symmetry, said body (3) comprising a first upper part (7) and a second lower part (8), with the second lower part (8) being integral with the bottom (6), said first and second parts (7, 8) being connected to one another by an intermediate zone (9), the first and second parts (7, 8) each having an essentially concave shape whose concavity faces toward the axis (Z) of symmetry of the body, the concave shape of the first part (7) being essentially the same as the concave shape of the second part (8), the intermediate zone (9) having a convex shape, whose convexity faces toward the axis (Z) of symmetry of the body (3), and, in a plane (P) comprising said axis (Z) of symmetry of the body (3), with said convexity and said concavity being essentially complementary for making possible the interlocking of a first or second part (7, 8) of a container (1) in an intermediate zone (9) of a second container (1),
filling the hollow container (1) with a flat or gaseous liquid (2),
and attaching a holding strip (10) around the body (3) of the container (1) in the intermediate zone (9), after the filling step.

6. Process for manufacturing a container according to claim 4, comprising the following steps:
producing the hollow container (1) by blow molding or stretch blow molding of a preform in a mold that has an impression that can produce a container (1) comprising a dome-shaped bottom (6) that is integral with a body (3), the bottom (6) and the body (3) having the same rotational axis (Z) of symmetry, said body (3) comprising a first upper part (7) and a second lower part (8), the second lower part (8) being integral with the bottom (6), said first and second parts (7, 8) being connected to one another by an intermediate zone (9), with the first and second parts (7, 8) each having an essentially concave shape whose concavity faces toward the axis (Z) of symmetry of the body (3), the concave shape of the first part (7) being essentially the same as the concave shape of the second part (8), the intermediate zone (9) having a convex shape, whose convexity faces toward the axis (Z) of symmetry of the body (3) and, in a plane (P) that comprises said axis (Z) of symmetry of the body (3), said convexity and said concavity being essentially complementary for making possible the interlocking of a first or second part (7, 8) of a container (1) in an intermediate zone (9) of a second container (1),
filling the hollow container (1) with a liquid,
adding gas into the liquid in such a way as to obtain a gasified liquid (2),
and attaching a holding strip (10) around the body (3) of the container (1) in the intermediate zone (9), after the step of adding gas.

7. Pack (11; 14) comprising at least four containers according to claim 1, wherein two contiguous containers (1) are positioned in such a manner that the first part (7) or the second part (8) of one is inserted into the intermediate zone (9) of the other.

8. Pack (11; 14) according to claim 7, wherein at least three containers (1) each have at least one point of their bottoms (6) in the same plane in such a way that the bottom (6) of each of the at least three containers (1) is able to be in contact with the same flat base (12).

9. Pack (11; 14) according to claim 7, wherein the containers (1) are oriented in the same direction and in the same sense.

10. Pack (11; 14) according to claim 7, wherein the containers are oriented in the same direction and positioned head to foot.

11. Pack (11) according to claim 7, wherein the containers (1) are held in position by a heat-shrink film (13).

12. Pack (14) according to claim 7 any of claims 7 to 10, wherein the containers (1) are held in position by a cardboard strip (15) surrounding the pack (14).

13. Container according to claim 2, wherein the intermediate zone (9) is surrounded by a holding strip (10).

14. Pack (11; 14) comprising at least four containers according to claim 2, wherein two contiguous containers (1) are positioned in such a manner that the first part (7) or the second part (8) of one is inserted into the intermediate zone (9) of the other.

15. Pack (11; 14) comprising at least four containers according to claim 3, wherein two contiguous containers (1) are positioned in such a manner that the first part (7) or the second part (8) of one is inserted into the intermediate zone (9) of the other.

16. Pack (11; 14) comprising at least four containers according to claim 4, wherein two contiguous containers (1) are positioned in such a manner that the first part (7) or the second part (8) of one is inserted into the intermediate zone (9) of the other.

17. Pack (11; 14) according to claim 8, wherein the containers (1) are oriented in the same direction and in the same sense.

18. Pack (11; 14) according to claim 8, wherein the containers are oriented in the same direction and positioned head to foot.
